(19) United States
(12) Patent Application Publication
(10) Pub. No.: US 2025/0272065 A1
(43) Pub. Date: Aug. 28, 2025

(54) WORKFLOW GENERATION BASED ON USER INPUTS

(71) Applicant: ServiceNow, Inc., Santa Clara, CA (US)

(72) Inventors: Jing Fei Chen, San Francisco, CA (US); Jacob Samuel Burman, Carlsbad, CA (US); Orlando Edson Marquez, Montreal (CA); Jennifer Lyons, San Diego, CA (US)

(21) Appl. No.: 18/588,911

(22) Filed: Feb. 27, 2024

(51) Int. Cl. G06F 8/34; G06Q 10/0633

(52) U.S. Cl. CPC G06F 8/34; G06Q 10/0633

(57) ABSTRACT

Systems and methods are provided for using machine learning (ML) models to design workflow patterns based on user inputs (e.g., provided as a natural language “utterance” (such as a free-text field entry) and/or as a computer programming language entry). The ML models are used to extract intents of the user inputs and predict workflow patterns based on the user intents. The ML models may be used to design a customized workflow based on the respective workflow criteria.

### TECHNICAL FIELD

The present disclosure relates generally to the field of workflow generation based on natural language understanding (NLU) and artificial intelligence (AI).

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations and these resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

Enterprises may have various core functions, and users may often spend time to add and/or modify functionalities (e.g., customized workflows) for their own business needs. For example, a user, who uses the computing resources of the cloud computing architecture, may need to design some workflows from scratch or to modify workflows to fit their own business needs. Accordingly, the user needs to be familiar with the corresponding software. The user may also want to modify a workflow designed using a product made by a first entity to be compatible with a product made by a second entity. In this case, the user needs to be familiar with the software products of both entities. However, such tasks may be difficult for non-technological users.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As mention previously, it may be desirable to generate customized workflows for business needs without starting from scratch. A customized workflow may be used for achieving a task or performing an operation for the business needs. A user may input the purpose of the task or the operation into one or more machine learning (ML) models, which may be used to extract “intents” of the user input (e.g., provided as a natural language “utterance” (such as a free-text field entry) and/or as a computer programming language entry) and design customized workflows based on the user input.

For example, the cloud computing service may host a virtual agent, such as a chat agent, which may be designed to automatically respond to issues with the client instance based on natural language requests from a user of the client instance. The virtual agent may be part of a Natural Language Processing (NLP) or Natural Language Understanding (NLU) system. NLP is a general area of computer science and AI that involves some form of processing of natural language input. Examples of areas addressed by NLP include language translation, speech generation, parse tree extraction, part-of-speech identification, and others. NLU is a sub-area of NLP that specifically focuses on understanding user utterances. Examples of areas addressed by NLU include question-answering (e.g., reading comprehension questions), article summarization, and others. For example, an NLU may use algorithms to reduce human language (e.g., spoken or written) into a set of known symbols for consumption by a downstream virtual agent. NLP is generally used to interpret free text for further analysis.

After the user intents are extracted (e.g., by the virtual agent), the ML models may be used to design the customized workflows based on the user intents. The ML models may be trained to predict workflow patterns based on the user intents from a set of pre-determined workflow patterns corresponding to known or frequently observed customizable workflows. The pre-determined workflow patterns may correspond to known purposes/intents of tasks or operations related to the business needs. For example, the pre-determined workflow patterns may include defining points that correspond to predefined purposes/intents. Based on the user intents and the purposes of the pre-determined workflow patterns, the ML models may map one or more of the pre-determined workflow patterns to the user intents to generate a customized workflow. In some embodiments, a computer programming language entry may be included in the user input, and the ML models may compare the computer programming language entry with the pre-determined workflow patterns to predict workflow patterns for the customized workflow. Each pre-determined workflow pattern may have a respective workflow criteria and respective key points, and the ML models may design the customized workflow based on the respective workflow criteria and key points of the pre-determined workflow patterns that are mapped to the customized workflow. The user may select and/or tailor functionalities of the customized workflow, such as via a dynamic natural language input and feedback loop (e.g., via the virtual agent). Accordingly, the user may generate customized workflows for business needs without starting from scratch.

With the foregoing in mind, present embodiments are directed to using ML models to design workflow patterns based on user inputs (e.g., provided as a natural language “utterance” (such as a free-text field entry) and/or as a computer programming language entry). The ML models may be used to extract intents of the user inputs and predict workflow patterns based on the user intents. The ML models may be trained to predict workflow patterns for a customized workflow from a set of pre-determined workflow patterns corresponding to known or frequently observed customizable workflows. The ML models may design the customized workflow based on the respective workflow criteria and key points of the pre-determined workflow patterns. The user may select and/or tailor functionalities of the customized workflows.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system in which embodiments of the present technique may operate;

FIG. 2 is a block diagram of an embodiment of a multi-instance cloud architecture in which embodiments of the present technique may operate;

FIG. 3 is a block diagram of a computing device utilized in a computing system that may be present in FIG. 1 or 2, in accordance with aspects of the present technique;

FIG. 4A is a schematic diagram illustrating an embodiment of an agent automation framework including an NLU framework that is part of a client instance hosted by a cloud computing system, in accordance with aspects of the present technique;

FIG. 4B is a schematic diagram illustrating an alternative embodiment of the agent automation framework in which portions of the NLU framework are part of an enterprise instance hosted by the cloud computing system, in accordance with aspects of the present technique;

FIG. 5 is a flow diagram illustrating an embodiment of a process for predicting a customized workflow based on user inputs, in accordance with aspects of the present technique;

FIG. 6 is an embodiment of a visualization of the user interface that may be used in FIG. 5 for generating or editing customized workflows, in accordance with aspects of the present technique;

FIG. 7 is a second embodiment of a visualization of the user interface that may be used in FIG. 5 for generating or editing customized workflows, in accordance with aspects of the present technique;

FIG. 8 is a third embodiment of a visualization of the user interface that may be used in FIG. 5 for generating or editing customized workflows, in accordance with aspects of the present technique;

FIG. 9 is a fourth embodiment of a visualization of the user interface that may be used in FIG. 5 for generating or editing customized workflows, in accordance with aspects of the present technique;

FIG. 10 is a fifth embodiment of a visualization of the user interface that may be used in FIG. 5 for generating or editing customized workflows, in accordance with aspects of the present technique; and

FIG. 11 is a flow diagram illustrating a method for predicting or editing a customized workflow based on user inputs, in accordance with aspects of the present technique.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the terms “application”, “engine”, “program”, or “plugin” refers to one or more sets of computer software instructions (e.g., computer programs and/or scripts) executable by one or more processors of a computing system to provide particular functionality. Computer software instructions can be written in any suitable programming languages, such as C, C++, C#, Pascal, Fortran, Perl, MATLAB, SAS, SPSS, JavaScript, AJAX, and JAVA. Such computer software instructions can comprise an independent application with data input and data display modules. Alternatively, the disclosed computer software instructions can be classes that are instantiated as distributed objects. The disclosed computer software instructions can also be component software, for example JAVABEANS or ENTERPRISE JAVABEANS. Additionally, the disclosed applications or engines can be implemented in computer software, computer hardware, or a combination thereof.

As used herein, the term “framework” refers to a system of applications and/or engines, as well as any other supporting data structures, libraries, modules, and any other supporting functionality, that cooperate to perform one or more overall functions. In particular, a “natural language understanding framework” or “NLU framework” comprises a collection of computer programs designed to process and derive meaning (e.g., intents, entities, artifacts) from natural language utterances using one or more machine-learning (ML) components and one or more rule-based components. As used herein, a “behavior engine” or “BE,” also known as a reasoning agent or RA/BE, refers to a rule-based agent, such as a virtual agent, designed to interact with users based on a conversation model. For example, a “virtual agent” may refer to a particular example of a BE that is designed to interact with users via natural language requests in a particular conversational or communication channel. With this in mind, the terms “virtual agent” and “BE” are used interchangeably herein. By way of specific examples, a virtual agent may be or include a chat agent that interacts with users via natural language requests and responses in a chat room environment, or that provides recommended answers to requests or queries made in a search text box. Other examples of virtual agents may include an email agent, a forum agent, a ticketing agent, a telephone call agent, a search agent, a genius search result agent, and so forth, which interact with users in the context of email, forum posts, search queries, autoreplies to service tickets, phone calls, and so forth.

As used herein, an “intent” refers to a desire or goal of a user which may relate to an underlying purpose of a communication, such as an utterance. As used herein, an “entity” refers to an object, subject, or some other parameterization of an intent. It is noted that, for present embodiments, certain entities are treated as parameters of a corresponding intent within an intent/entity model. More specifically, certain entities (e.g., time and location) may be globally recognized and extracted for all intents, while other entities are intent-specific (e.g., merchandise entities associated with purchase intents) and are generally extracted only when found within the intents that define them. As used herein, “artifact” collectively refers to both intents and entities of an utterance. As used herein, an “intent/entity model” (also referred to herein as an “intent-entity model”) refers to a model that associates particular intents with particular entities and particular sample utterances, wherein entities associated with the intent may be encoded as a parameter of the intent within the sample utterances of the model. As used herein, an “understanding model” or “NLU model” is a collection of models and parameters used by the NLU framework to infer meaning of natural language utterances. An understanding model may include a search space with meaning representations (e.g., utterance trees) compiled from sample utterances of various intents indicated in an intent/entity model, a word vector distribution model that associates certain tokens (e.g., words or phrases) with particular word vectors, an intent/entity model, an intent model, an entity model, a taxonomy model, other models, or a combination thereof.

As used herein, the term “agents” may refer to computer-generated personas (e.g. chat agents or other virtual agents) that interact with human users within a conversational channel. As used herein, a “corpus” may refer to a captured body of source data that can include interactions between various users and virtual agents, wherein the interactions include communications or conversations within one or more suitable types of media (e.g., a help line, a chat room or message string, an email string). As used herein, an “utterance tree” refers to a data structure that stores a representation of the meaning of an utterance. As discussed, an utterance tree has a tree structure (e.g., a dependency parse tree structure) that represents the syntactic structure of the utterance, wherein nodes of the tree structure store vectors (e.g., word vectors, subtree vectors) that encode the semantic meaning of the utterance.

As used herein, an “utterance” refers to a single natural language statement made by a user that may include one or more intents. As such, an utterance may be part of a previously captured corpus of source data, and an utterance may also be a new statement received from a user as part of an interaction with a virtual agent. As used herein, “machine learning” or “ML” may be used to refer to any suitable statistical form of artificial intelligence capable of being trained using machine learning techniques, including supervised, unsupervised, and semi-supervised learning techniques. For example, in certain embodiments, ML-based techniques may be implemented using an artificial neural network (ANN) (e.g., a deep neural network (DNN), a recurrent neural network (RNN), a recursive neural network, a feedforward neural network). In contrast, “rules-based” methods and techniques refer to the use of rule-sets and ontologies (e.g., manually-crafted ontologies, statistically-derived ontologies) that enable precise adjudication of linguistic structure and semantic understanding to derive meaning representations from utterances. As used herein, a “vector” (e.g., a word vector, an intent vector, a pattern vector, a subject vector, a subtree vector, a vector representation) refers to a linear algebra vector that is an ordered n-dimensional list (e.g., a 300 dimensional list) of floating point values (e.g., a 1×N or an N×1 matrix) that provides a mathematical representation of the semantic meaning of a portion (e.g., a word or phrase, an intent, an entity, a token) of an utterance. As used herein, “domain specificity” refers to how attuned a system is to correctly extracting intents and entities expressed in actual conversations in a given domain and/or conversational channel (e.g., a human resources domain, an information technology domain). As used herein, an “understanding” of an utterance refers to an interpretation or a construction of the utterance by the NLU framework. As such, it may be appreciated that different understandings of an utterance may be associated with different meaning representations having different parse structures (e.g., different nodes, different relationships between nodes), different part-of-speech taggings, and so forth.

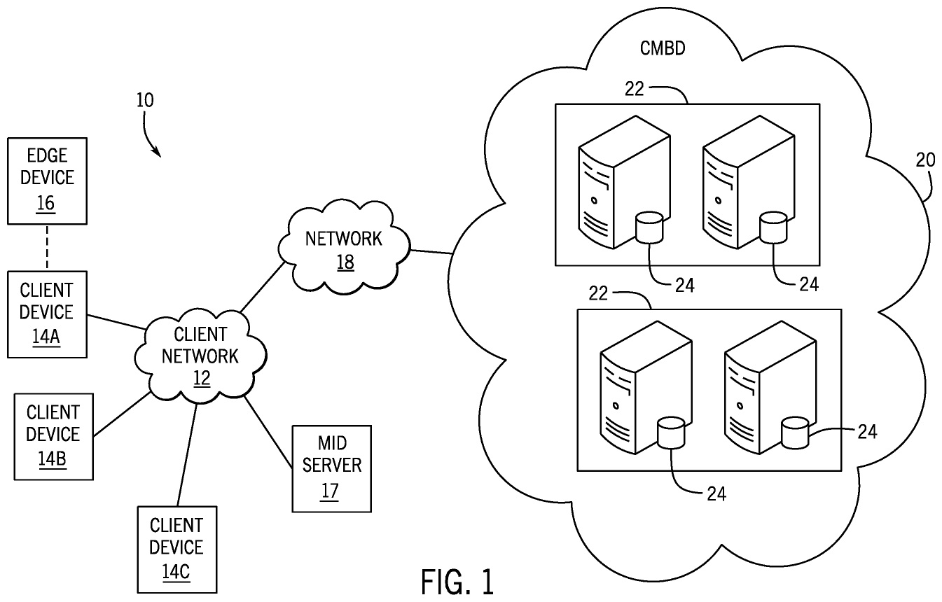

With the preceding in mind, the following figures relate to various types of generalized system architectures or configurations that may be employed to provide services to an organization. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. Computing system 10 may include a client network 12, network 18 (e.g., the Internet), and a cloud-based platform 20. In some implementations, the cloud-based platform may host a management database (CMDB) system and/or other suitable systems. In one embodiment, the client network 12 may be a local private network, such as a local area network (LAN) having a variety of network devices that include, but are not limited to, switches, servers, and routers. In another embodiment, the client network 12 represents an enterprise network that could include one or more LANs, virtual networks, data centers 22, and/or other remote networks. As shown in FIG. 1, the client network 12 is able to connect to one or more client devices 14A, 14B, and 14C so that the client devices are able to communicate with each other and/or with the network hosting the platform 20. The client devices 14A-C may be computing systems and/or other types of computing devices generally referred to as Internet of Things (IoT) devices that access cloud computing services, for example, via a web browser application or via an edge device 16 that may act as a gateway between the client devices and the platform 20. FIG. 1 also illustrates that the client network 12 includes an administration or managerial device, agent, or server, such as a management, instrumentation, and discovery (MID) server 17 that facilitates communication of data between the network hosting the platform 20, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 18. The network 18 may include one or more computing networks, such as other LANs, wide area networks (WAN), the Internet, and/or other remote networks, to transfer data between the client devices 14A-C and the network hosting the platform 20. Each of the computing networks within network 18 may contain wired and/or wireless programmable devices that operate in the electrical and/or optical domain. For example, network 18 may include wireless networks, such as cellular networks (e.g., Global System for Mobile Communications (GSM) based cellular network), IEEE 802.11 networks, and/or other suitable radio-based networks. The network 18 may also employ any number of network communication protocols, such as Transmission Control Protocol (TCP) and Internet Protocol (IP). Although not explicitly shown in FIG. 1, network 18 may include a variety of network devices, such as servers, routers, network switches, and/or other network hardware devices configured to transport data over the network 18.

In FIG. 1, the network hosting the platform 20 may be a remote network (e.g., a cloud network) that is able to communicate with the client devices 14A-C via the client network 12 and network 18. The network hosting the platform 20 provides additional computing resources to the client devices 14A-C and/or client network 12. For example, by utilizing the network hosting the platform 20, users of client devices 14A-C are able to build and execute applications for various enterprise, IT, and/or other organization-related functions. In one embodiment, the network hosting the platform 20 is implemented on one or more data centers 22, where each data center could correspond to a different geographic location. Each of the data centers 22 includes a plurality of virtual servers 24 (also referred to herein as application nodes, application servers, virtual server instances, application instances, or application server instances), where each virtual server can be implemented on a physical computing system, such as a single electronic computing device (e.g., a single physical hardware server) or across multiple-computing devices (e.g., multiple physical hardware servers). Examples of virtual servers 24 include, but are not limited to a web server (e.g., a unitary web server installation), an application server (e.g., unitary JAVA Virtual Machine), and/or a database server, e.g., a unitary relational database management system (RDBMS) catalog.

To utilize computing resources within the platform 20, network operators may choose to configure the data centers 22 using a variety of computing infrastructures. In one embodiment, one or more of the data centers 22 are configured using a multi-tenant cloud architecture, such that one of the server instances 24 handles requests from and serves multiple customers. Data centers with multi-tenant cloud architecture commingle and store data from multiple customers, where multiple customer instances are assigned to one of the virtual servers 24. In a multi-tenant cloud architecture, the particular virtual server 24 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 24 causing outages for all customers allocated to the particular server instance.

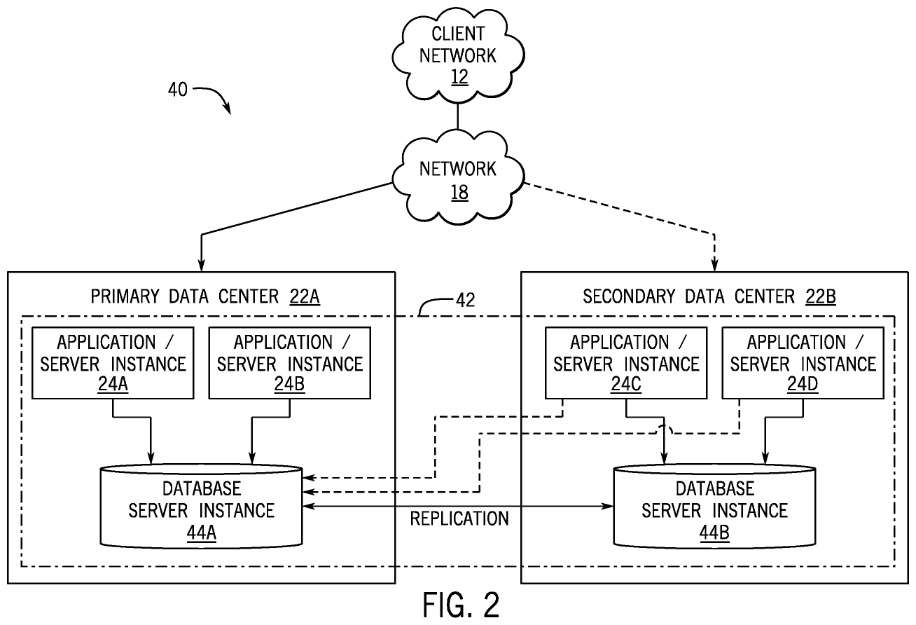

In another embodiment, one or more of the data centers 22 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 24, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 20, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a simply client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances and are specific to the respective client instance 42. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 20 is implemented using data centers, other embodiments of the platform 20 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 24A-D and virtual database servers 44A and 44B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

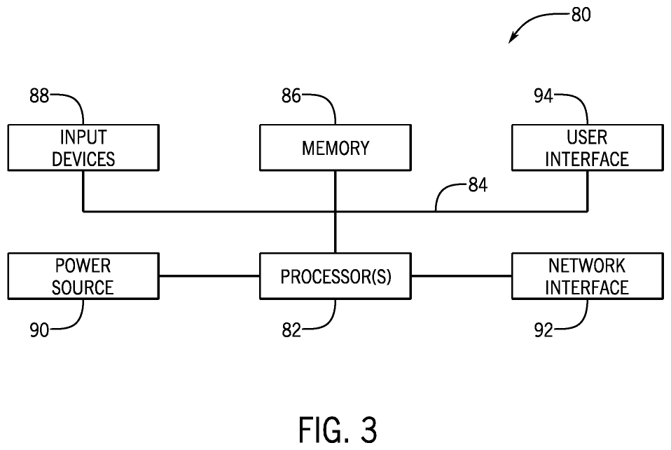

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 80 and their potential interconnections or communication paths, such as along one or more busses. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein.

The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 include suitable electrical channels to provide data and/or power between the various components of the computing system 80. The memory 86 may include any tangible, non-transitory, and computer-readable storage media. Although shown as a single block in FIG. 3, the memory 86 can be implemented using multiple physical units of the same or different types in one or more physical locations. The input devices 88 correspond to structures to input data and/or commands to the one or more processors 82. For example, the input devices 88 may include a mouse, touchpad, touchscreen, keyboard and the like. The power source 90 can be any suitable source for power of the various components of the computing system 80, such as line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

It should be appreciated that the cloud-based platform 20 discussed above provides an example architecture that may utilize NLU technologies. In particular, the cloud-based platform 20 may include or store a large corpus of source data that can be leveraged (e.g., “mined”) to facilitate the generation of a number of outputs, including an intent/entity model. The generated intent/entity model can serve as a basis for classifying intents in future requests, as discussed herein. As such, in certain embodiments described herein, the disclosed agent automation framework is incorporated into the cloud-based platform 20, while in other embodiments, the agent automation framework may be hosted and executed (separately from the cloud-based platform 20) by a suitable system that is communicatively coupled to the cloud-based platform 20 to process utterances, as discussed below.

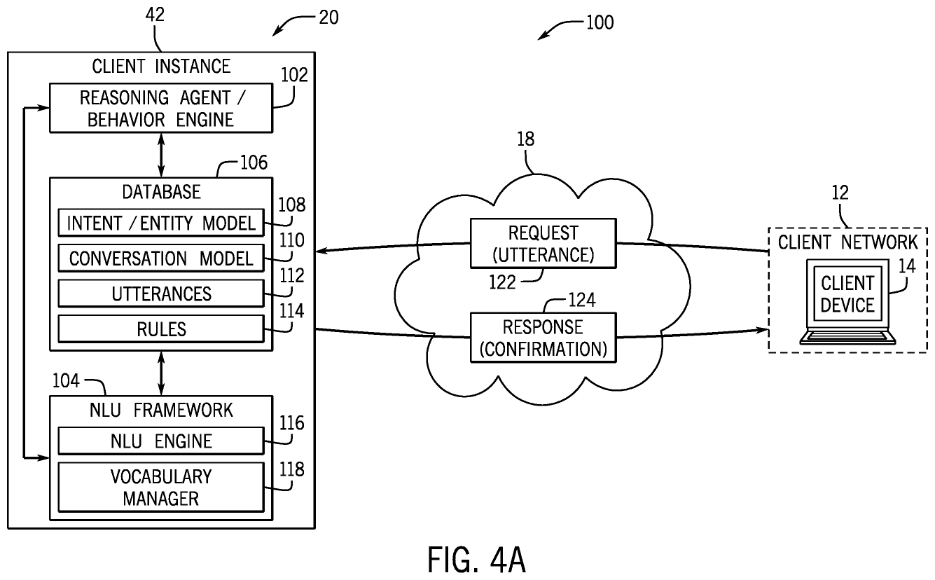

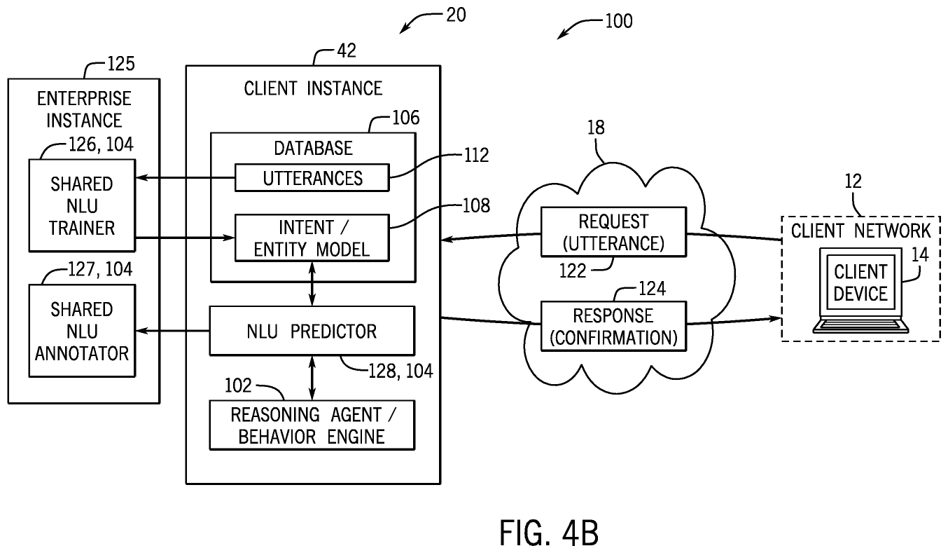

With the foregoing in mind, FIG. 4A illustrates an agent automation framework 100 associated with a client instance 42, in accordance with embodiments of the present technique. The agent automation framework 100 may be capable of extracting meaning from user utterances, such as requests received by a virtual agent (e.g., a chat agent), and suitably responding to these user utterances. More specifically, FIG. 4A illustrates an example of a portion of a service provider cloud infrastructure, including the cloud-based platform 20 discussed above. The cloud-based platform 20 is connected to a client device 14 via the network 18 to provide a user interface to network applications executing within the client instance 42 (e.g., via a web browser of the client device 14). Client instance 42 is supported by virtual servers similar to those explained with respect to FIG. 2, and is illustrated here to show support for the disclosed functionality described herein within the client instance 42. The cloud provider infrastructure is generally configured to support a plurality of end-user devices, such as client device 14, concurrently, wherein each end-user device is in communication with the single client instance 42. Also, the cloud provider infrastructure may be configured to support any number of client instances, such as client instance 42, concurrently, with each of the instances in communication with one or more end-user devices. As mentioned above, an end-user may also interface with client instance 42 using an application that is executed within a web browser.

The embodiment of the agent automation framework 100 illustrated in FIG. 4A includes a reasoning agent/behavior engine (RA/BE) 102, a NLU framework 104, and a database 106, which are communicatively coupled within the client instance 42. The RA/BE 102 may host or include any suitable number of virtual agents or personas that interact with the user of the client device 14 via natural language user requests 122 (e.g., user utterances) and agent responses 124 (e.g., agent utterances or agent confirmations). It may be noted that, in actual implementations, the agent automation framework 100 may include a number of other suitable components, including the meaning extraction subsystem, the meaning search subsystem, and so forth, in accordance with the present disclosure.

For the embodiment illustrated in FIG. 4A, the database 106 may be a database server instance 44, as discussed with respect to FIG. 2), or a collection of database server instances. The illustrated database 106 stores an intent/entity model 108, a conversation model 110, a corpus of utterances 112, and a collection of rules 114 in one or more tables (e.g., relational database tables) of the database 106. The intent/entity model 108 stores associations or relationships between particular intents and particular sample utterances. In certain embodiments, the intent/entity model 108 may be authored by a designer using a suitable authoring tool. However, it should be noted that such intent/entity models typically include a limited number of sample utterances provided by the designer. Additionally, designers may have limited linguistic knowledge and, furthermore, are constrained from reasonably providing a comprehensive list of all possible ways of specifying intents in a domain. It is also presently recognized that, since the meaning associated with various intents and entities is continuously evolving within different contexts (e.g., different language evolutions per domain, per cultural setting, per client, and so forth), authored intent/entity models generally are manually updated over time. As such, it is recognized that authored intent/entity models are limited by the time and ability of the designer, and as such, these human-generated intent/entity models can be limited in both scope and functionality.

With this in mind, in certain embodiments, the intent/entity model 108 may instead be generated from a corpus of utterances 112. More specifically, the intent/entity model 108 may be generated based on the corpus of utterances 112 and the collection of rules 114 stored in one or more tables of the database 106. It may be appreciated that the corpus of utterances 112 may include source data collected with respect to a particular context, such as chat logs between users and a help desk technician within a particular enterprise, from a particular group of users, communications collected from a particular window of time, and so forth. As such, the corpus of utterances 112 enable the agent automation framework 100 to build an understanding of intents and entities that appropriately correspond with the terminology and diction that may be particular to certain contexts and/or technical fields, as discussed in greater detail below.

For the embodiment illustrated in FIG. 4A, the conversation model 110 stores associations between intents of the intent/entity model 108 and particular responses and/or actions, which generally define the behavior of the RA/BE 102. In certain embodiments, at least a portion of the associations within the conversation model are manually created or predefined by a designer of the RA/BE 102 based on how the designer wants the RA/BE 102 to respond to particular identified intents/entities in processed utterances. It should be noted that, in different embodiments, the database 106 may include other database tables storing other information related to intent classification, such as tables storing information regarding compilation model template data (e.g., class compatibility rules, class-level scoring coefficients, tree-model comparison algorithms, tree substructure vectorization algorithms), meaning representations, and so forth, in accordance with the present disclosure.

For the illustrated embodiment, the NLU framework 104 includes a NLU engine 116 and a vocabulary manager 118 (also referred to herein as a vocabulary subsystem). It may be appreciated that the NLU framework 104 may include any suitable number of other components. In certain embodiments, the NLU engine 116 is designed to perform a number of functions of the NLU framework 104, including generating word vectors (e.g., intent vectors, subject or entity vectors, subtree vectors) from word or phrases of utterances, as well as determining distances (e.g., Euclidean distances) between these vectors. For example, the NLU engine 116 is generally capable of producing a respective intent vector for each intent of an analyzed utterance. As such, a similarity measure or distance between two different utterances can be calculated using the respective intent vectors produced by the NLU engine 116 for the two intents, wherein the similarity measure provides an indication of similarity in meaning between the two intents.

The vocabulary manager 118, which may be part of the vocabulary subsystem discussed below, addresses out-of-vocabulary words and symbols that were not encountered by the NLU framework 104 during vocabulary training. For example, in certain embodiments, the vocabulary manager 118 can identify and replace synonyms and domain-specific meanings of words and acronyms within utterances analyzed by the agent automation framework 100 (e.g., based on the collection of rules 114), which can improve the performance of the NLU framework 104 to properly identify intents and entities within context-specific utterances. Additionally, to accommodate the tendency of natural language to adopt new usages for pre-existing words, in certain embodiments, the vocabulary manager 118 handles repurposing of words previously associated with other intents or entities based on a change in context. For example, the vocabulary manager 118 could handle a situation in which, in the context of utterances from a particular client instance and/or conversation channel, the word “bike” actually refers to a motorcycle rather than a bicycle.

Once the intent/entity model 108 and the conversation model 110 have been created, the agent automation framework 100 is designed to receive a user utterance 122 (in the form of a natural language request) and to appropriately take action to address the request. For example, for the embodiment illustrated in FIG. 4A, the RA/BE 102 is a virtual agent that receives, via the network 18, the utterance 122 (e.g., a natural language request in a chat communication) submitted by the client device 14 disposed on the client network 12. The RA/BE 102 provides the utterance 122 to the NLU framework 104, and the NLU engine 116, along with the various subsystems of the NLU framework 104 discussed below, processes the utterance 122 based on the intent/entity model 108 to derive intents/entities within the utterance 122. Based on the intents/entities derived by the NLU engine 116, as well as the associations within the conversation model 110, the RA/BE 102 performs one or more particular predefined actions. For the illustrated embodiment, the RA/BE 102 also provides a response 124 (e.g., a virtual agent utterance or confirmation) to the client device 14 via the network 18, for example, indicating actions performed by the RA/BE 102 in response to the received user utterance 122. Additionally, in certain embodiments, the utterance 122 may be added to the utterances 112 stored in the database 106 for continued learning within the NLU framework 104, as discussed below.

It may be appreciated that, in other embodiments, one or more components of the agent automation framework 100 and/or the NLU framework 104 may be otherwise arranged, situated, or hosted for improved performance. For example, in certain embodiments, one or more portions of the NLU framework 104 may be hosted by an instance (e.g., a shared instance, an enterprise instance) that is separate from, and communicatively coupled to, the client instance 42. It is presently recognized that such embodiments can advantageously reduce the size of the client instance 42, improving the efficiency of the cloud-based platform 20. In particular, in certain embodiments, one or more components of the semantic mining framework discussed below may be hosted by a separate instance (e.g., an enterprise instance) that is communicatively coupled to the client instance 42, as well as other client instances, to enable semantic intent mining and generation of the intent/entity model 108.

With the foregoing in mind, FIG. 4B illustrates an alternative embodiment of the agent automation framework 100 in which portions of the NLU framework 104 are instead executed by a separate, shared instance (e.g., enterprise instance 125) that is hosted by the cloud-based platform system 20. The illustrated enterprise instance 125 is communicatively coupled to exchange data related to intent/entity mining and classification with any suitable number of client instances via a suitable protocol (e.g., via suitable Representational State Transfer (REST) requests/responses). As such, for the design illustrated in FIG. 4B, by hosting a portion of the NLU framework 104 as a shared resource accessible to multiple client instances 42, the size of the client instance 42 can be substantially reduced (e.g., compared to the embodiment of the agent automation framework 100 illustrated in FIG. 4A) and the overall efficiency of the agent automation framework 100 can be improved.

In particular, the NLU framework 104 illustrated in FIG. 4B is divided into three distinct components that perform different aspects of semantic mining and intent classification within the NLU framework 104. These components include: a shared NLU trainer 126 hosted by the enterprise instance 125, a shared NLU annotator 127 hosted by the enterprise instance 125, and a NLU predictor 128 hosted by the client instance 42. It may be appreciated that the organizations illustrated in FIGS. 4A and 4B are merely examples, and in other embodiments, other organizations of the NLU framework 104 and/or the agent automation framework 100 may be used, in accordance with the present disclosure.

For the embodiment of the agent automation framework 100 illustrated in FIG. 4B, the shared NLU trainer 126 is designed to receive the corpus of utterances 112 from the client instance 42, and to perform semantic mining (e.g., including semantic parsing, grammar engineering, and so forth) to facilitate generation of the intent/entity model 108. Once the intent/entity model 108 has been generated, when the RA/BE 102 receives the user utterance 122 provided by the client device 14, the NLU predictor 128 passes the utterance 122 and the intent/entity model 108 to the shared NLU annotator 127 for parsing and annotation of the utterance 122. The shared NLU annotator 127 performs semantic parsing, grammar engineering, and so forth, of the utterance 122 based on the intent/entity model 108 and returns annotated utterance trees of the utterance 122 to the NLU predictor 128 of client instance 42. The NLU predictor 128 then uses these annotated structures of the utterance 122 to identify matching intents from the intent/entity model 108, such that the RA/BE 102 can perform one or more actions based on the identified intents. It may be appreciated that the shared NLU annotator 127 may correspond to the meaning extraction subsystem and the NLU predictor may correspond to the meaning search subsystem of the NLU framework 104.

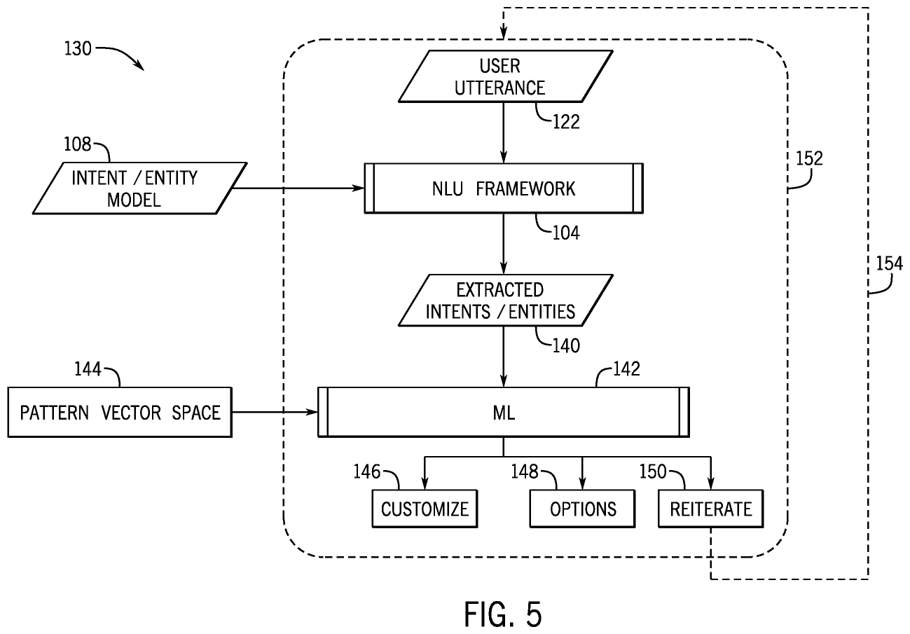

FIG. 5 is a flow diagram illustrating an embodiment of a process 130 for predicting a customized workflow based on user inputs (e.g., user utterances 122). For the illustrated embodiment, the NLU framework 104 processes a received user utterance 122 to extract intents/entities 140 based on the intent/entity model 108. The extracted intents/entities 140 may be implemented as a collection of symbols that represent intents and entities of the user utterance 122 in a form that is consumable by the RA/BE 102. The extracted intents/entities 140 may be provided to ML models 142, which, in certain embodiments, maps the received intents/entities 140 to one or more pre-determined workflow patterns in an N-dimensional (e.g., N=1, 2, 3 . . . ) pattern vector space 144. The N-dimensional pattern vector space 144 may include number N of pre-determined workflow pattern (e.g., pattern-1, pattern-2 . . . pattern-N) axes, and a pattern vector in the pattern vector space 144 may have a set of parameters along respective pattern axes in the pattern vector space 144. The pre-determined workflow patterns may correspond to known purposes of tasks or operations associated with various business needs. For example, pattern-1 axis of the pattern vector space 144 may correspond to a pre-determined workflow pattern regarding decision making, pattern-2 axis of the pattern vector space 144 may correspond to a pre-determined workflow pattern regarding job scheduling, pattern-3 axis of the pattern vector space 144 may correspond to a pre-determined workflow pattern regarding error handling, and so on.

Based on the extracted intents/entities 140 and the known purposes of the pre-determined workflow patterns, the ML models 142 may map one or more of the pre-determined workflow patterns in the pattern vector space 144 to the extracted intents/entities 140 to generate a pattern vector for a customized workflow 146. The ML models 142 may then design the customized workflow 146 based on the pattern vector. In some embodiments, the extracted intents/entities 140 of a user input (e.g., the user utterance 122) may be mapped to one pre-determined workflow pattern in the pattern vector space 144. For example, the extracted intents/entities 140 of a user input (e.g., the user utterance 122) may correspond to job scheduling, and a pattern vector along the pre-determined workflow pattern axis regarding job scheduling (e.g., pattern-2 axis) may be used to design the customized workflow 146. In some embodiments, the extracted intents/entities 140 of a user input (e.g., the user utterance 122) may be mapped to more than one pre-determined workflow patterns in the pattern vector space 144. For example, the extracted intents/entities 140 of a user input (e.g., the user utterance 122) may correspond to job scheduling and decision making, and a pattern vector having a set of parameters along respective pattern axes (e.g., pattern-1 axis, pattern-2 axis) in the pattern vector space 144 may be used to design the customized workflow 146.

In some embodiments, the ML models 142 may design the customized workflow 146 further based on an order of the set of parameters of the pattern vector. For example, a customized workflow 146 may have functionalities including making a decision first and scheduling the job based on the decision made, while another customized workflow 146 may have functionalities including scheduling a job first and making a decision based on a condition of the job. Both of the above customized workflows include the pre-determined workflow patterns regarding job scheduling and decision making and may correspond to a same pattern factor in the pattern vector space 144. In some embodiments, one pre-determined workflow pattern (e.g., along pattern-1 axis) may be used multiple times (e.g., the pattern vector may have a parameter more than 1 along the patter-1 axis) when generating the customized workflow 146.

In some embodiments, a computer programming language entry may be included in the user input, and the ML models 142 may compare the computer programming language entry with the pre-determined workflow patterns in the pattern vector space 144 to predict workflow patterns for the customized workflow 146. For example, the ML models 142 may predict one or more pre-determined workflow patterns in the pattern vector space 144 for the computer programming language entry by using the nearest neighbor search method or other suitable search methodologies.

In addition, each pre-determined workflow pattern may have a respective workflow criteria and respective key points (e.g., crucial points), which may include one or more steps and/or functionalities of the workflow. The ML models 142 may design the customized workflow 146 based on the respective workflow criteria and key points of the pre-determined workflow patterns in the pattern vector. For example, when the extracted intents/entities 140 of a user input (e.g., the user utterance 122) are mapped to a pre-determined workflow pattern in the pattern vector space 144, the workflow criteria and key points of the pre-determined workflow pattern may be included in the customized workflow 146. When the extracted intents/entities 140 of a user input (e.g., the user utterance 122) are mapped to more than one pre-determined workflow patterns in the pattern vector space 144, the pattern vector may have a set of parameters along respective pattern axes (e.g., pattern-1 axis, pattern-2 axis) in the pattern vector space 144, and the customized workflow 146 may be designed by using the set of parameters. In the above embodiment, the workflow criteria and key points of all the pre-determined workflow patterns in the pattern vector may be included in the customized workflow 146.

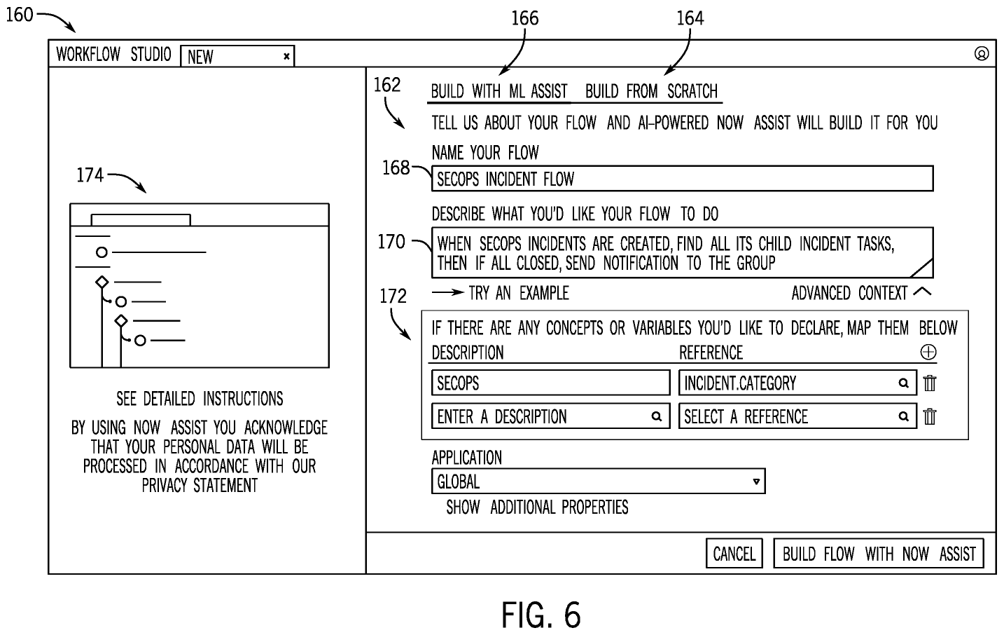

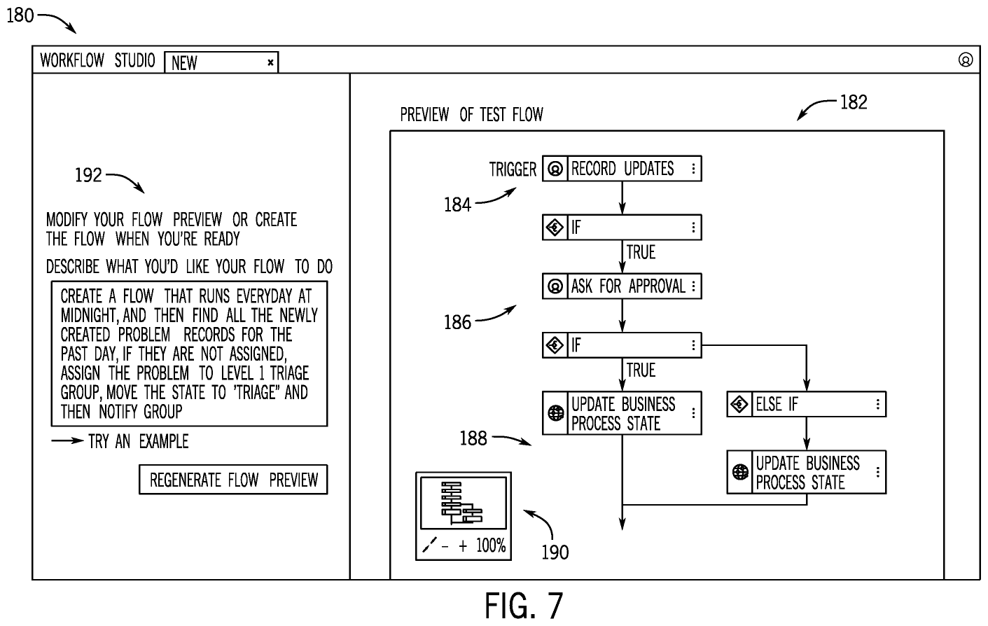

The ML models 142 may generate a user interface (e.g., a graphic user interface (GUI)) to present the customized workflow 146 to the user, such as for review or modification. The user may select and/or tailor functionalities of the customized workflow 146 on the user interface, such as via a dynamic natural language input and feedback loop, as illustrated in FIG. 6 to FIG. 11. In some embodiments, the ML models 142 may generate more than one customized workflow 146 and present them as selectable options 148 on the user interface for the user. The user interface may also provide an option 150 (e.g., as illustrated in FIG. 7) to reiterate the process 152 of generating the customized workflow 146. As indicated by the arrow 154, the process 152 may be continuously repeated based on the user's selection on the user interface. The ML models 142 may update the pattern vector space 144 based on the user activities, such as adding the workflow patterns of the customized workflow 146 to the pattern vector space 144 (e.g., the user may frequently use a set of workflow patterns in the customized workflow 146), modifying some existing pre-determined workflow patterns in the pattern vector space 144 based on the user's edits to the customized workflow 146, deleting some pre-determined workflow patterns from the pattern vector space 144, and so on.

It should be noted that, while the user utterance 122 and the agent utterance 124 are discussed herein as being conveyed using a written conversational medium or channel (e.g., chat, email, ticketing system, text messages, forum posts), in other embodiments, voice-to-text and/or text-to-voice modules or plugins could be included to translate spoken user utterance 122 into text and/or translate text-based agent utterance 124 into speech to enable a voice interactive system, in accordance with the present disclosure. Furthermore, in certain embodiments, both the user utterance 122 and the virtual agent utterance 124 may be stored in the database 106 (e.g., in the corpus of utterances 112) to enable continued learning of new structure and vocabulary within the agent automation framework 100.

FIG. 6 illustrates a visualization 160 (e.g., graphic user interface (GUI)) of the user interface that may be used in FIG. 5 for generating or editing workflows. In FIG. 6, an introduction component 162 is shown with options for generating workflows, such as an option component 164 for an option to build the workflows from scratch, an option component 166 for an option to build the workflows with ML assist, etc. Users may input properties and descriptions for a workflow using the respective option components (e.g., the option component 164, the option component 166) for generating the workflow. For example, the option component 166 may include a title component 168 for inputting the title for the workflow, a description component 170 for inputting descriptions for the workflow, a property component 172 for selecting or inputting properties/parameters (e.g., description, reference, application type, additional properties) for the workflow. The description component 170 may enable users to input a user request (e.g., provided as a natural language “utterance” (such as a free-text field entry)). The NLU framework 104 may extract the intents of the user request, and the ML models 142 may generate the workflow based on the extracted user intents. The visualization 160 may also include an instruction component 174 to provide guidelines or instructions for generating the workflow (e.g., privacy instruction).

FIG. 7 illustrates a portion of a visualization 180 (e.g., graphic user interface (GUI)) of the user interface that may be used in FIG. 5 for generating or editing workflows. In the visualization 180, a preview component 182 may be used to preview functionalities of the workflow (e.g., the customized workflow 146), such as a trigger function 184, an actions function 186, etc. The actions function 186 (as well as other functions) may include multiple subfunctions 188. The preview component 182 may include a zooming option 190 for selecting zooming scales (e.g., 75%, 100%, 150%) to show the preview for the workflow in the preview component 182. The visualization 180 may include an input component 192 for users to input instructions for the workflow (e.g., modify, generate, reiterate). The user input component 192 may enable users to input user request (e.g., provided as a natural language “utterance” (such as a free-text field entry)). The NLU framework 104 may extract the intents of the user request, and the ML models 142 may generate or edit the workflow based on the extracted user intents.

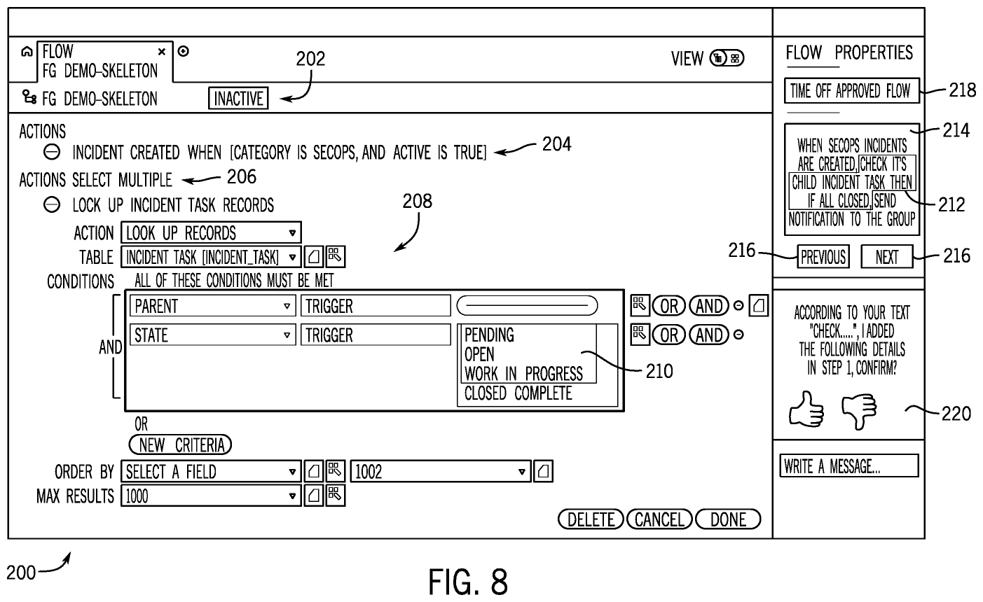

FIG. 8 illustrates a visualization 200 (e.g., graphic user interface (GUI)) of the user interface that may be used in FIG. 5 for generating or editing customized workflows. In FIG. 8, a portion of a customized workflow 202 is shown with functionalities, such as a trigger function 204, an actions function 206, etc. A properties component 208 (e.g., action, table, conditions, order by, max results, delete, cancel, done) may be used to select options/filters for the actions function 206. Some part of the properties component 208 may be highlighted in a highlight portion 210, which corresponds to a highlight portion 212 in a user input component 214. The user input component 214 may enable users to input user request manually (e.g., user utterance) or upload from a file (e.g., for computer programming language entry). The NLU framework 104 may extract the intents of the user request, and the ML models 142 may generate or edit the customized workflow 202 based on the extracted user intents. The highlighted portion 212 of the user input and the highlighted portion 210 of the properties component 208 may be mapped (e.g., by using a same highlight color or other visual indicators) as a highlight portion pair to indicate the relationship between the user input included in the highlight portion 212 and corresponding edits made in the customized workflow 202. Users may input instructions in the user input component 214 for generating or modifying the customized workflow 202, and the users may have options to review the input instructions (e.g., by using the “previous” and “next” buttons 216). Users may also input the title of the customized workflow in a title component 218. Users may confirm/reject the edits included in the highlight portion 210 in the decision component 220. Although only one highlight portion pair (e.g., the highlight portion 212 and the highlight portion 210) is illustrated in the embodiment of FIG. 8, more than one highlight portion pairs may be used in other embodiments. By mapping the user input with the edits caused by the user input to the customized workflow, the users may connect the user input with the edits of the customized workflow and increase the efficiency to generate/modify a customized workflow.

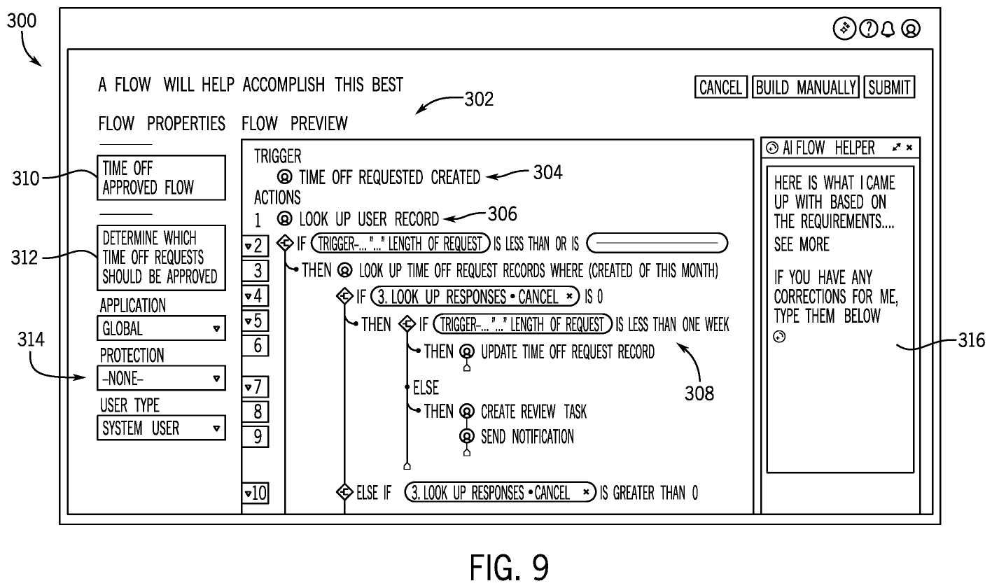

FIG. 9 illustrates a visualization 300 (e.g., graphic user interface (GUI)) of the user interface that may be used in FIG. 5 for generating and editing customized workflows. In FIG. 9, a portion of a customized workflow 302 is shown with functionalities, such as a trigger function 304, an actions function 306, etc. The actions function 306 may include multiple subfunctions 308. The visualization 300 may include components for the users to input properties of the customized workflow 302, such as a title component 310 for inputting the title of the customized workflow, a description component 312 for inputting description of the customized workflow. The visualization 300 may also include filter components 314 to select filters/options (e.g., application, protection, user type) for the customized workflow 302. An artificial intelligence (AI) tool 316 may be used to provide helpful instructions for generating and editing the customized workflow 302.

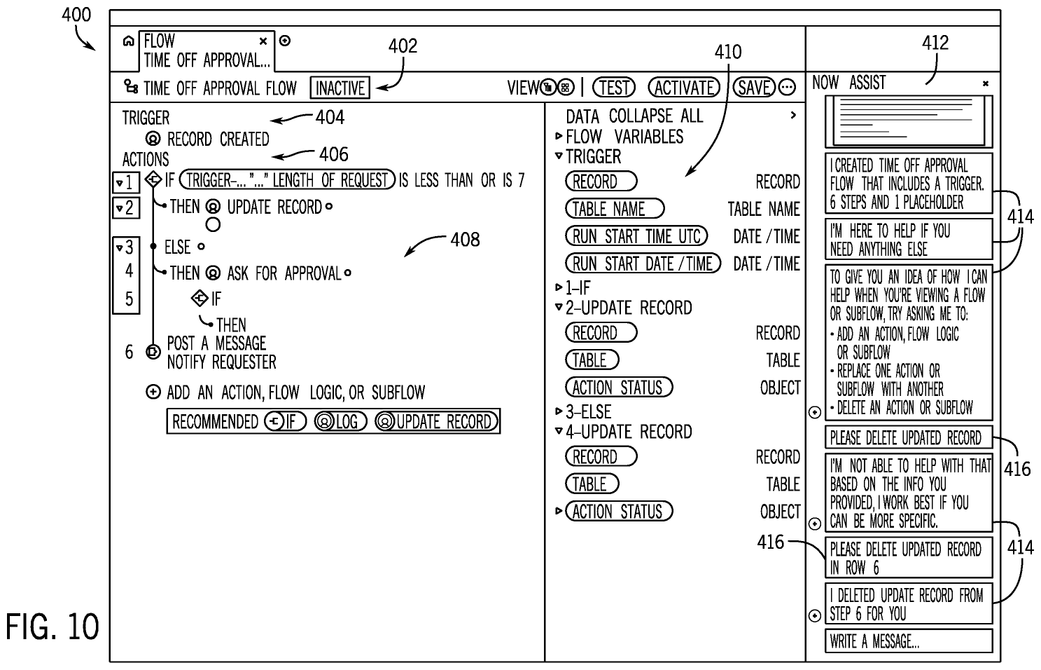

FIG. 10 illustrates a visualization 400 (e.g., graphic user interface (GUI)) of the user interface that may be used in FIG. 5 for generating and editing customized workflows. In FIG. 10, a portion of a customized workflow 402 is shown with functionalities, such as a trigger function 404, an actions function 406, etc. The actions function 406 may include multiple subfunctions 408. The visualization 400 may include properties components 410 for the users to select properties for the customized workflow 402, such as flow variables, trigger, etc. A chatbot 412 may be used for real-time chatting between the users and the virtual agent, for example, the virtual agent may provide helpful instructions 414 and the users may input request 416 for generating and editing the customized workflow 402. The NLU framework 104 may extract the intents of the user request 416, and the ML models 142 may generate or edit the customized workflow 402 based on the extracted user intents.

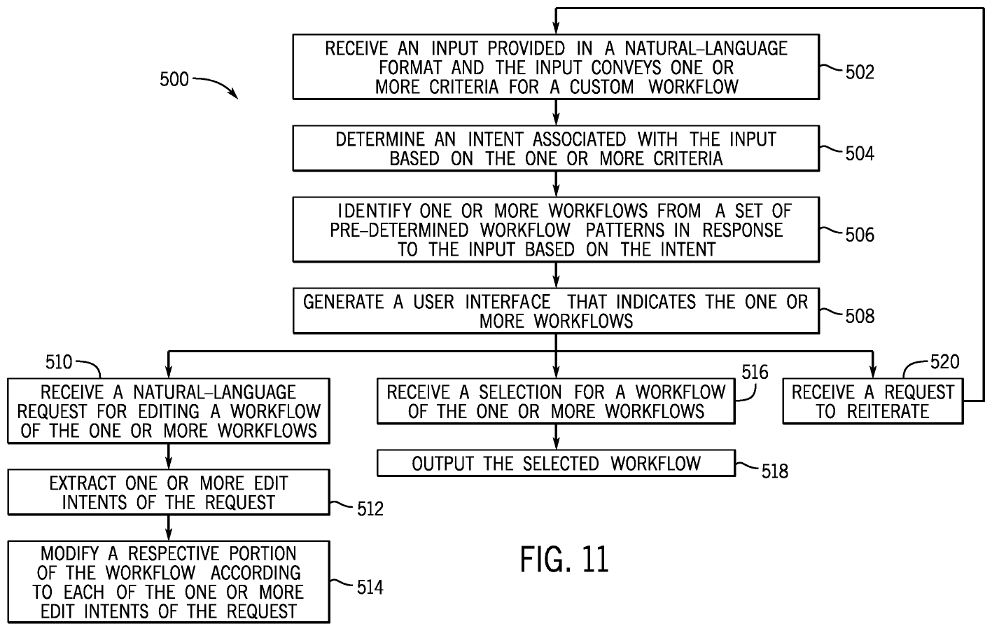

FIG. 11 illustrates a flow diagram of a method 500 for predicting and/or editing a customized workflow (e.g., the customized workflow 146) based on user inputs (e.g., via the visualization 160, via the visualization 180, via the visualization 200, via the visualization 300, via the visualization 400) by using a computing system (e.g., the computing system 80). At block 502, the NLU framework 104 may receive an input provided in a natural language format (e.g., the user utterance 122) and the input conveys one or more criteria for a custom workflow (e.g., from the description component 170 and/or the property component 172, from the user input component 192, from the description component 312 and/or the filter components 314). In some embodiments, a computer programming language entry may be or may be included in the input (e.g., uploaded from a file at the user input component 214). At block 502, the NLU framework 104 may process (e.g., based on the intent/entity model 108) the input to extract an intent (e.g., the extracted intents/entities 140) associated with the input based on the one or more criteria conveyed by the input, as illustrated in FIG. 5.

At block 506, the extracted intent may be provided to the ML model(s) 142, which, in certain embodiments, maps the received intent to one or more pre-determined workflow patterns (e.g., in an N-dimensional pattern vector space 144) based on the extracted intent. As discussed with respect to FIG. 5, the ML model(s) 142 may determine one or more workflows (e.g., the customized workflow 146) using the one or more pre-determined workflow patterns based on the intent. At block 508, text or graphics indicative of the one or more workflows determined in block 506 may be generated and displayed on a user interface (e.g., in the visualization 180, in the visualization 200, in the visualization 300, in the visualization 400).

Users may use the user interface to modify a workflow of the one or more workflows. For example, the NLU framework 104 may receive a natural-language request from users (e.g., from the user input component 214) for editing a workflow of the one or more workflows at block 510. The NLU framework 104 may then extract one or more edit intents of the request at block 512. At block 514, the ML model(s) 142 may modify the selected workflow according to the one or more edit intents of the request extracted at block 512. In some embodiments, the ML model(s) 142 may modify a respective portion of the workflow according to each of the one or more edit intents of the request, and the user interface may utilize a respective visual indicator to indicate the relationship between the respective modified portion of the workflow (e.g., the highlight portion 210) and the portion of the request (e.g., the highlight portion 212) corresponding to the edit intent, as illustrated in FIG. 8.

Users may also use the user interface to select a workflow from the one or more workflows. For example, the computing system may receive a selection (e.g., via the selectable options 148) of a workflow from the one or more workflows via the user interface at block 516. After receiving the selection, the computing system may output the selected workflow at block 518, such as display the selected workflow on the user interface, store it in the memory (e.g., memory 86), or transmit it to other devices (e.g., through the network interface 92), etc. Users may also use the user interface to reiterate the process (e.g., via the option 150). For example, at block 520, the computing system may receive a request to reiterate the process of generating the workflows (e.g., via the user input component 192 in FIG. 7), and the computing system may repeat the blocks 502 to 508.

Technical effects of this section of the present disclosure include using ML models to design workflow patterns based on user inputs (e.g., provided as a natural language “utterance” (such as a free-text field entry) and/or as a computer programming language entry). The ML models may be used to extract intents of the user inputs and predict workflow patterns based on the user intents. The ML models may be trained to predict workflow patterns for a customized workflow from a set of pre-determined workflow patterns corresponding to known or frequently observed customizable workflows. The ML models may design the customized workflow based on the respective workflow criteria and key points of the pre-determined workflow patterns. The user may select and/or tailor functionalities of the customized workflow, such as via a dynamic natural language input and feedback loop (e.g., via the virtual agent). Accordingly, the user may generate customized workflows for business needs without starting from scratch.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A method comprising:
receiving a user input, wherein the user input is provided in a natural-language format and conveys one or more criteria for a custom workflow;
determining an intent associated with the user input based on the one or more criteria;
identifying one or more workflows from a set of pre-determined workflow patterns in response to the user input based on the intent; and
generating a user interface that indicates the one or more workflows.

2. The method of claim 1, wherein the one or more workflows are identified by using one or more machine learning models that are trained to:
determine one or more pattern vectors in a pattern vector space based on the intent, wherein the pattern vector space comprises a plurality of pattern axes each corresponding to a respective pre-determined workflow pattern, and wherein the respective pre-determined workflow pattern comprises one or more defining points and corresponds to one or more respective predefined intents; and
determine the one or more workflows for the user input based on the one or more pattern vectors and a respective criteria for the respective pre-determined workflow pattern, wherein the respective criteria is associated with the one or more defining points of the respective pre-determined workflow pattern.

3. The method of claim 2, wherein the one of the one or more pattern vectors comprise at least two pre-determined workflow patterns.

4. The method of claim 1, comprising:
receiving a natural-language request for editing a workflow of the one or more workflows;
in response to the natural-language request, extracting one or more edit intents of the natural-language request; and
modifying a respective portion of the workflow according to each of the one or more edit intents.

5. The method of claim 4, comprising:
indicating the modified respective portion of the workflow and corresponding edit intent of the one or more edit intents using a respective visual indicator.

6. The method of claim 5, wherein the respective visual indicator comprises highlighting the modified respective portion and the corresponding edit intent.

7. The method of claim 1, comprising:
receiving, via the user interface, a selection for a workflow of the one or more workflows; and
in response to receiving the selection, outputting the selected workflow.

8. A system comprising:
one or more processors; and
memory accessible by the one or more processors, the memory storing instructions that, when executed by the one or more processors, cause the one or more processors to perform operations comprising:
receiving a user input, wherein the user input is provided in a natural-language format and conveys one or more criteria for a custom workflow;
determining an intent associated with the user input based on the one or more criteria;
identifying one or more workflows from a set of pre-determined workflow patterns in response to the input based on the intent; and
generating a user interface that indicates the one or more workflows.

9. The system of claim 8, wherein the one or more workflows are identified by using one or more machine learning models that are trained to:
determine one or more pattern vectors in a pattern vector space based on the intent, wherein the pattern vector space comprises a plurality of pattern axes each corresponding to a respective pre-determined workflow pattern, and wherein the respective pre-determined workflow pattern comprises one or more defining points and corresponds to one or more respective predefined intents; and
determine the one or more workflows for the user input based on the one or more pattern vectors and a respective criteria for the respective pre-determined workflow pattern, wherein the respective criteria is associated with the one or more defining points of the respective pre-determined workflow pattern.

10. The system of claim 9, wherein the one of the one or more pattern vectors comprise at least two pre-determined workflow patterns.

11. The system of claim 8, wherein the operations comprise:
receiving a natural-language request for editing a workflow of the one or more workflows;
in response to the natural-language request, extracting one or more edit intents of the natural-language request; and
modifying a respective portion of the workflow according to each of the one or more edit intents.

12. The system of claim 11, wherein the operations comprise:
indicating the modified respective portion of the workflow and corresponding edit intent of the one or more edit intents using a respective visual indicator.

13. The system of claim 12, wherein the respective visual indicator comprises highlighting the modified respective portion and the corresponding edit intent.

14. The system of claim 8, wherein the operations comprise:
receiving, via the user interface, a selection for a workflow of the one or more workflows; and
in response to receiving the selection, outputting the selected workflow.

15. A tangible, non-transitory computer readable storage media storing instructions that, when executed by one or more processors, cause the one or more processors to perform operations comprising:
receiving a user input, wherein the user input is provided in a natural-language format and conveys one or more criteria for a custom workflow;
determining an intent associated with the user input based on the one or more criteria;
identifying one or more workflows from a set of pre-determined workflow patterns in response to the user input based on the intent; and
generating a user interface that indicates the one or more workflows.

16. The non-transitory computer readable storage media of claim 15, wherein the one or more workflows are identified by using one or more machine learning models that are trained to:
determine one or more pattern vectors in a pattern vector space based on the intent, wherein the pattern vector space comprises a plurality of pattern axes each corresponding to a respective pre-determined workflow pattern, and wherein the respective pre-determined workflow pattern comprises one or more defining points and corresponds to one or more respective predefined intents; and
determine the one or more workflows for the user input based on the one or more pattern vectors and a respective criteria for the respective pre-determined workflow pattern, wherein the respective criteria is associated with the one or more defining points of the respective pre-determined workflow pattern.

17. The non-transitory computer readable storage media of claim 16, wherein the one of the one or more pattern vectors comprise at least two pre-determined workflow patterns.

18. The non-transitory computer readable storage media of claim 15, wherein the operations comprise:
receiving a natural-language request for editing a workflow of the one or more workflows;
in response to the natural-language request, extracting one or more edit intents of the natural-language request; and
modifying a respective portion of the workflow according to each of the one or more edit intents.

19. The non-transitory computer readable storage media of claim 18, wherein the operations comprise:
indicating the modified respective portion of the workflow and corresponding edit intent of the one or more edit intents using a respective visual indicator.

20. The non-transitory computer readable storage media of claim 19, wherein the respective visual indicator comprises highlighting the modified respective portion and the corresponding edit intent.
